(19) United States
(12) Patent Application Publication
(10) Pub. No.: US 2016/0218538 A1
(43) Pub. Date: Jul. 28, 2016

(54) RECHARGEABLE ILLUMINATION DEVICE

(71) Applicant: Jung-Chou TSAO, Chang Hua County (TW)

(72) Inventor: Jung-Chou TSAO, Chang Hua County (TW)

(21) Appl. No.: 14/604,243

(22) Filed: Jan. 23, 2015

(51) Int. Cl. H02J 7/00; H05B 37/02

(52) U.S. Cl. CPC H02J 7/0052; H05B 37/02

(57) ABSTRACT

A rechargeable illumination device includes an USB input unit, a booster circuit, a manage unit, a battery unit, and an illumination unit. Therein, the USB input unit is for inputting a direct current. The booster circuit is connected with the USB input unit for boosting the voltage of the direct current up to 6.5V. The manage unit is electrically connected with the booster circuit. The battery unit includes a plurality of rechargeable batteries for being electrically connected with the manage unit. The illumination unit is electrically connected with the battery unit. With such configuration, the manage unit charges the battery unit with the boosted direct current, so as to provide a sufficient power source to the illumination unit.

### BACKGROUND OF THE INVENTION

1. Field of the Invention

The present invention relates to illumination devices, and more particularly, to a rechargeable illumination device.

2. Description of the Related Art

Known portable lamps usually apply one-time batteries as a power source thereof, but one-time batteries are not rechargeable and reusable. Also, one-time batteries are supposed to be abandoned after being used, whereby waste of resource and environmental pollution are caused.

Some lamps nowadays apply rechargeable batteries as the power source thereof, which mainly uses an adapter to transform the external alternating current (AC) into the direct current (DC), so as to charge the rechargeable batteries in the lamps. However, the cost of such adapter remains relatively high. Also, such adapter fails to meet the requirement of being conveniently portable.

Further, there are different models of lamps applying an USB port to be connected with an external power source, so as to charge the rechargeable batteries. However, an ordinary USB port is only applicable to an output voltage of 5V. Such voltage limitation is only allowed to charge four 1.4V batteries. Under this circumstance, the rechargeable batteries might not be fully recharged even with a certain degree of damage to the batteries caused thereupon. Thus, conventional lamps fail to meet the current user demand.

### SUMMARY OF THE INVENTION

For improving the aforementioned issues, the present invention discloses a rechargeable illumination device, which applies a booster circuit to boost the input direct current up to 6.5V, so as to fully charge the battery unit of the present invention, thereby providing a sufficient power source to the illumination unit.

For achieving the aforementioned objective, the present invention provides a rechargeable illumination device, comprising:

an USB input unit, for inputting a direct current (DC);

a booster circuit, connected with the USB input unit for boosting the voltage of the direct current up to 6.5V;

a manage unit, electrically connected with the booster circuit;

a battery unit, including a plurality of rechargeable batteries for being electrically connected with the manage unit; and

an illumination unit, electrically connected with the battery unit.

With such configuration, the manage unit charges the battery unit with the boosted direct current, so as to provide a sufficient power source to the illumination unit.

Preferably, with the management of the manage unit provided by the present invention, the charging process enters a slow charging mode when the battery unit is charged to 350 mAh.

Preferably, with the management of the manage unit, the charging process stops when the battery unit is charged to a voltage ranged from 5V to 5.6V.

Preferably, with the management of the manage unit, the battery unit stops providing the power to the illumination unit when the voltage of the battery unit is under 3.3V.

Preferably, the present invention further comprises an LED indicator unit connected to the manage unit, such that the LED indicator unit lights up during the charging process of the battery unit.

Preferably, the battery unit provided by the present invention includes four rechargeable batteries.

Preferably, the rechargeable batteries of the present invention are nickel-hydrogen batteries.

### BRIEF DESCRIPTION OF THE DRAWINGS

FIG. 1 is a schematic block chart illustrating the structure of the rechargeable illumination device in accordance with the present invention.

FIG. 2 is a schematic block chart illustrating the battery unit in accordance with the present invention.

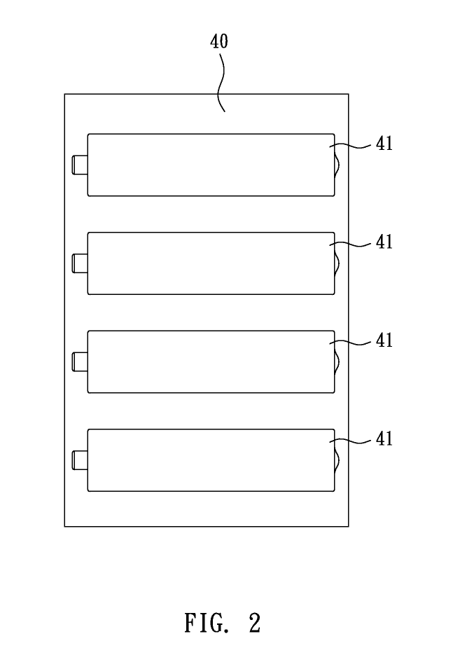

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

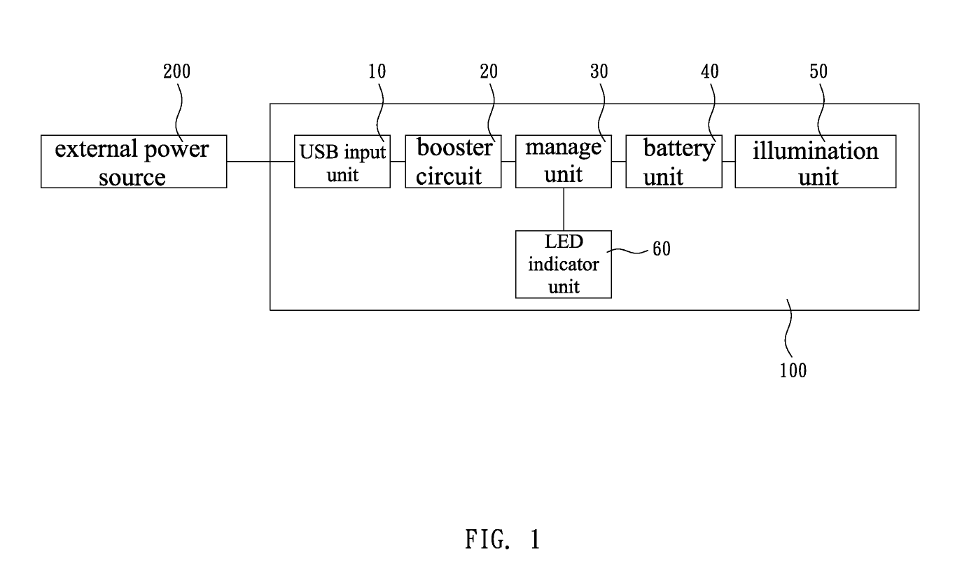

Referring to FIG. 1, the present invention provides a rechargeable illumination device 100, comprising an USB input unit 10, a booster circuit 20, a manage unit 30, a battery unit 40, and an illumination unit 50.

The USB input unit 10 is allowed to be an USB plug seat for electrically connecting an external power source 200 having an USB plug, such as a computer, so as to input a direct current (DC). Also, the input power of the USB input unit 10 is 5V/500 mAh.

The booster circuit 20 is electrically connected to the USB input unit 10 for boosting or regulating an input direct current into a steady voltage, wherein the steady voltage in the present invention is a voltage of 6.5V.

The manage unit 30 is electrically connected between the booster circuit 20 and the battery unit 40 for controlling the steady voltage output from the booster circuit 20, thereby charging the battery unit 40. In the embodiment provided by the present invention, the battery unit 40 includes a plurality of rechargeable batteries 41; in the preferred embodiment, the plurality of rechargeable batteries 41 are four nickel-hydrogen batteries.

The illumination unit 50 is electrically connected with the battery unit 40, such that the battery unit 40 provides the power source to the illumination unit 50, facilitating the operation of the illumination unit 50.

With the foregoing configuration, due to the manage unit 30 provided by the present invention, the charging process enters a slow charging mode when the battery unit 40 is charged to 350 mAh, and the charging process stops when the battery unit 40 is charged to a voltage ranged from 5V to 5.6V, so as to prevent the battery unit 40 from being overcharged. Also, the manage unit 30 further stops the battery unit 40 from providing power source to the illumination unit 50 when the voltage of the battery unit 40 is under 3.3V.

Therefore, the present invention applies the USB input unit 10 to be connected with the external power source 200, so as to charge the battery unit 40 in a manner of DC to DC, saving the demand of charging the battery unit 40 with additional adapter, thus providing convenience of usage.

Furthermore, the voltage of the rechargeable batteries 41 provided by the present invention is at 1.4V; the booster circuit 20 is applied for boosting the voltage up to a steady voltage of 6.5V, so as to fully charge the four rechargeable batteries 41. Compared with conventional charging method focusing on only three batteries, the charging process of the present invention possesses higher usability and efficacy.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A rechargeable illumination device, comprising:
an USB input unit, for inputting a direct current;
a booster circuit, connected with the USB input unit for boosting the voltage of the direct current up to 6.5V;
a manage unit, electrically connected with the booster circuit;
a battery unit, including a plurality of rechargeable batteries for being electrically connected with the manage unit; and
an illumination unit, electrically connected with the battery unit, such that the manage unit charges the battery unit with the boosted direct current, so as to provide a sufficient power source to the illumination unit.

2. The rechargeable illumination device of claim 1, wherein the input power of the USB input unit is 5V/500 mAh.

3. The rechargeable illumination device of claim 1, wherein the charging process of the battery unit enters a slow charging mode when the battery unit is charged to 350 mAh.

4. The rechargeable illumination device of claim 1, wherein the charging process stops when the battery unit is charged to a voltage ranged from 5V to 5.6V.

5. The rechargeable illumination device of claim 1, wherein the battery unit stops providing the power to the illumination unit when the voltage of the battery unit is under 3.3V.

6. The rechargeable illumination device of claim 1, further comprising an LED indicator unit connected to the manage unit, such that the LED indicator unit lights up during the charging process of the battery unit.

7. The rechargeable illumination device of claim 1, wherein the battery unit includes four rechargeable batteries.

8. The rechargeable illumination device of claim 7, wherein the rechargeable batteries are nickel-hydrogen batteries.
